(19) United States
(12) Patent Application Publication
(10) Pub. No.: US 2025/0210259 A1
(43) Pub. Date: Jun. 26, 2025

(54) CAPACITOR

(71) Applicant: TDK Corporation, Tokyo (JP)

(72) Inventors: Hisashi KOBAYASHI, Tokyo (JP); Kenichi Kamehashi, Tokyo (JP); Mei Tanaka, Tokyo (JP); Shinya Ito, Tokyo (JP); Akihiro Masuda, Tokyo (JP); Hiyori Sato, Tokyo (JP)

(73) Assignee: TDK Corporation, Tokyo (JP)

(21) Appl. No.: 18/933,048

(22) Filed: Oct. 31, 2024

(30) Foreign Application Priority Data
Dec. 26, 2023 (JP) 2023-219209

(51) Int. Cl. H01G 4/012; H01G 4/236; H01G 4/38

(52) U.S. Cl. CPC H01G 4/012; H01G 4/236; H01G 4/38

(57) ABSTRACT

A capacitor includes: an element body having a pair of main surfaces facing each other; a first electrode, a second electrode, and a common electrode portion provided on any of the main surfaces of the element body; a first lead terminal connected to the first electrode by soldering; and

a second lead terminal connected to the second electrode by soldering, in which the first electrode and the common electrode portion face each other with the element body interposed therebetween to form a first capacitor unit, the second electrode and the common electrode portion face each other with the element body interposed therebetween to form a second capacitor unit, the first capacitor unit and the second capacitor unit are connected in series, and the first electrode and the second electrode are insulated from each other on a surface of the element body.

### CROSS-REFERENCE TO RELATED APPLICATIONS

This application is based upon and claims the benefit of priority from Japanese Patent Application No. 2023-219209, filed on Dec. 26, 2023, the entire contents of which are incorporated herein by reference.

### TECHNICAL FIELD

The present disclosure relates to a capacitor.

### BACKGROUND

As a conventional capacitor, a capacitor described in Japanese Unexamined Patent Publication No. 2011-091335 is known. This capacitor includes: a plate-shaped element main body constituting an element main body of an electronic component; an electrode film formed on each of front and back surfaces of a substrate; two lead wires each having a connection portion electrically connected to the electrode film, and a lead leg portion extending outward from the connection portion; and an exterior resin covering a periphery of the element main body to which the connection portion of the lead wire is connected.

### SUMMARY

Here, in the capacitor as described above, a capacitor unit is formed between an electrode on a main surface formed on one side of an element body and an electrode on the other main surface. As described above, the above-described capacitor includes one capacitor unit.

In the capacitor, it has been required to improve resistance to voltage.

An object of the present disclosure is to provide a capacitor capable of improving the resistance to voltage.

A capacitor according to an embodiment of the present disclosure includes: an element body having a pair of main surfaces facing each other; a first electrode, a second electrode, and a common electrode portion provided on any of the main surfaces of the element body; a first lead terminal connected to the first electrode by soldering; and a second lead terminal connected to the second electrode by soldering, in which the first electrode and the common electrode portion face each other with the element body interposed therebetween to form a first capacitor unit, the second electrode and the common electrode portion face each other with the element body interposed therebetween to form a second capacitor unit, the first capacitor unit and the second capacitor unit are connected in series, and the first electrode and the second electrode are insulated from each other on a surface of the element body.

The capacitor includes the first lead terminal connected to the first electrode and the second lead terminal connected to the second electrode. Therefore, the capacitor can be mounted on a circuit board by the lead terminal. The capacitor includes the common electrode portion in addition to the first electrode and the second electrode. With the first electrode and the common electrode portion facing each other with the element body interposed therebetween, the first capacitor unit is formed. Further, with the second electrode and the common electrode portion facing each other with the element body interposed therebetween, the second capacitor unit is formed. The first capacitor unit and the second capacitor unit are connected in series. On the other hand, since the first electrode and the second electrode are insulated from each other on the surface of the element body, flow of current between both the electrodes can be suppressed. The current flowing between the first electrode and the second electrode to which the lead terminals are connected does not directly flow between the electrodes, but flows in series to the first capacitor unit and the second capacitor unit. In this manner, a plurality of capacitor units connected in series can be formed in one element body. Since a voltage applied to each capacitor unit can be reduced, the resistance to voltage of the capacitor can be improved. Thus, the resistance to voltage of the capacitor can be improved.

The first electrode and the second electrode may be provided on one of the main surfaces, the common electrode portion may be provided on the other of the main surfaces and include a common electrode facing the first electrode and the second electrode, the first capacitor unit and the second capacitor unit may be connected in series with the common electrode interposed therebetween, and the first electrode and the second electrode may be insulated from each other on the one of the main surfaces. In this manner, two capacitor units directly connected by one element body can be formed.

The common electrode portion may include a plurality of common electrodes, and the plurality of common electrodes may face each other with the element body interposed therebetween. In this case, three or more capacitor units can be formed by using the plurality of common electrodes.

The common electrode portion may include a first common electrode and a second common electrode, the first electrode and the first common electrode may face each other with the element body interposed therebetween to form the first capacitor unit, the second electrode and the second common electrode may face each other with the element body interposed therebetween to form the second capacitor unit, and the first common electrode and the second common electrode may face each other with the element body interposed therebetween to form a third capacitor unit. In this case, three capacitor units connected in series by one element body can be formed.

When viewed from a first direction in which the pair of main surfaces faces each other, inner peripheral side portions of the first electrode, the second electrode, the first common electrode, and the second common electrode may form predetermined angles, the angles of the first electrode and the second electrode may be approximately 120°, and the angles of the first common electrode and the second common electrode may be approximately 240°. In this case, capacitances of the three capacitor units can be made substantially equal. Therefore, it is possible to suppress variation in the resistance to voltage in each capacitor unit.

The first electrode and the second common electrode may be provided on one of the main surfaces, and the second electrode and the first common electrode may be provided on the other of the main surfaces. In this case, the first lead terminal is disposed on one main surface side, and the second lead terminal is disposed on the other main surface side. Thus, the element body can be sandwiched between the lead terminals. Therefore, thickness of the exterior resin on each main surface can be made uniform.

The common electrode portion may include a first common electrode, a second common electrode, and a third common electrode, the first electrode and the first common electrode may face each other with the element body interposed therebetween to form the first capacitor unit, the second electrode and the second common electrode may face each other with the element body interposed therebetween to form the second capacitor unit, the first common electrode and the third common electrode may face each other with the element body interposed therebetween to form a fourth capacitor unit, and the second common electrode and the third common electrode may face each other with the element body interposed therebetween to form a fifth capacitor unit. In this case, four capacitor units connected in series by one element body can be formed.

When viewed from a first direction in which the pair of main surfaces faces each other, inner peripheral side portions of the first electrode, the second electrode, the first common electrode, and the second common electrode, and the third common electrode may form predetermined angles,

the angles of the first electrode and the second electrode may be approximately 90°, and

the angles of the first common electrode, the second common electrode, and the third common electrode may be approximately 180°. In this case, capacitances of the four capacitor units can be made substantially equal. Therefore, it is possible to suppress variation in the resistance to voltage in each capacitor unit.

The first electrode, the second electrode, and the third common electrode may be provided on one of the main surfaces, and the first common electrode and the second common electrode may be provided on the other of the main surfaces. Thus, both the lead terminals can be arranged on the one main surface side. Therefore, the lead terminals can have the same shape, length, or the like.

An exterior resin may be disposed between the first electrode and the second electrode. In this case, a short circuit or the like between the first electrode and the second electrode can be suppressed, and the resistance to voltage of the capacitor can be improved.

A member electrically connected to the first electrode via solder may be only the first lead terminal. That is, a resistor or the like is not connected to the first electrode. In this case, it is possible to suppress generation of stray capacitance between the first electrode and the second electrode, and form the capacitor units connected in series.

Facing areas of electrodes and common electrodes in a plurality of capacitor units may be substantially equal to each other. In this case, the capacitances of the respective capacitor units can be made substantially equal to each other, and by making voltages applied to the respective capacitor units substantially equal, a short circuit failure or the like in any of the capacitor units can be suppressed, and breakdown can be suppressed.

According to the present disclosure, it is possible to provide a capacitor capable of improving the resistance to voltage.

### BRIEF DESCRIPTION OF THE DRAWINGS

FIG. 1 is a front view illustrating a single-plate capacitor according to an embodiment of the present disclosure;

FIG. 2 is a sectional view taken along line II-II illustrated in FIG. 1;

FIGS. 3A to 3C are views illustrating a structure of an electrode and a common electrode;

FIGS. 4A and 4C are views illustrating a structure of the electrode and the common electrode of the single-plate capacitor according to a modification;

FIGS. 5A and 5C are views illustrating a structure of the electrode and the common electrode of the single-plate capacitor according to the modification;

FIGS. 6A to 6C are views illustrating a structure of the electrode and the common electrode of the single-plate capacitor according to the modification;

FIGS. 7A to 7C are views illustrating a structure of the electrode of the single-plate capacitor according to a comparative example; and

FIG. 8 is a table showing simulation results.

### DETAILED DESCRIPTION

Hereinafter, embodiments of the present disclosure will be described in detail with reference to the accompanying drawings. Note that in description, the same reference numerals will be used for the same elements or elements having the same function, and redundant description will be omitted.

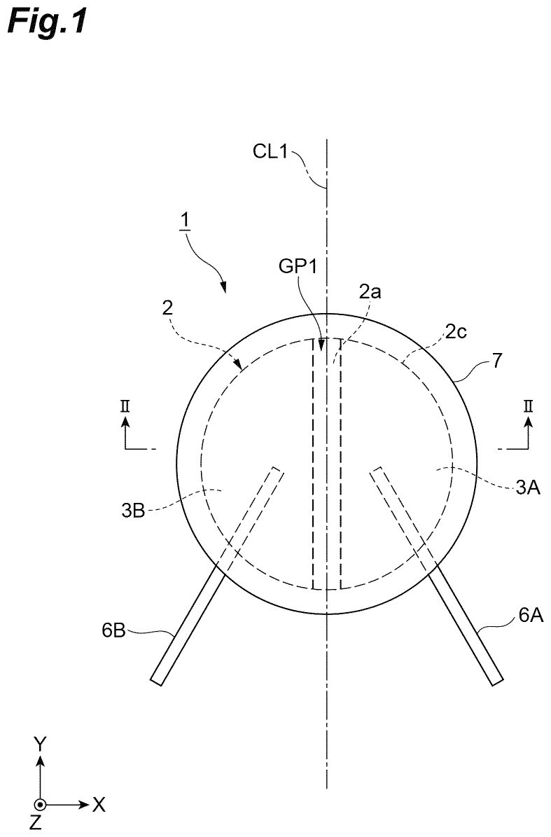

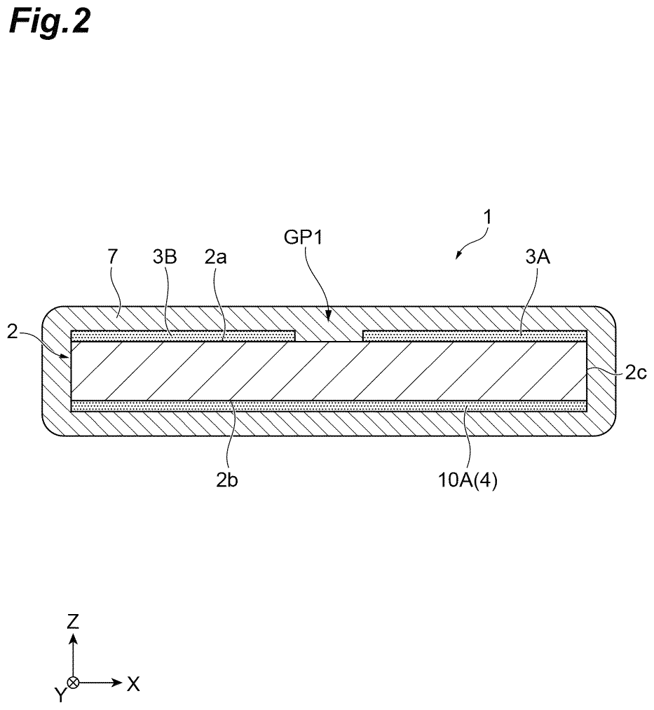

A configuration of a single-plate capacitor 1 according to the present embodiment will be described with reference to FIGS. 1 and 2. FIG. 1 is a front view illustrating the single-plate capacitor according to the present embodiment. FIG. 2 is a sectional view taken along line II-II illustrated in FIG. 1. The single-plate capacitor 1 (capacitor) is an electronic component that can be mounted on a circuit board. The single-plate capacitor 1 is a capacitor component using a one plate-shaped element body 2. The single-plate capacitor 1 is a flat plate-like capacitor containing dielectric ceramics, and has a configuration different from that of a laminate in which an internal electrode is formed. Note that for convenience of description, the description will be given by setting an XYZ coordinate system. A Y-axis direction is a direction perpendicular to an X-axis direction. A Z-axis direction is a direction perpendicular to the X-axis direction and the Y-axis direction. When a center line CL1 extending in the Y-axis direction is set, a shape of the single-plate capacitor 1 when viewed from the Z-axis direction is symmetrical with respect to the center line CL1.

First, an example of the single-plate capacitor 1 in which two capacitor units are connected in series will be described. As illustrated in FIGS. 1 and 2, the single-plate capacitor 1 includes the element body 2, a first electrode 3A, a second electrode 3B, a common electrode portion 4, a first lead terminal 6A, a second lead terminal 6B, and an exterior resin 7.

The element body 2 includes, for example, a dielectric element. The dielectric element includes, for example, a sintered body containing a dielectric material (dielectric ceramic such as BaTiO₃-based, Ba(Ti,Zr)O₃-based, or (Ba,Ca)TiO₃-based). An entire shape of the element body 2 is a disk shape or a flat columnar shape. The element body 2 has a pair of circular main surface 2a (one main surface) and main surface 2b (the other main surface) facing each other, and an outer peripheral surface 2c connecting the main surfaces 2a and 2b. The element body 2 has a facing direction of the main surfaces 2a and 2b in the Z-axis direction. The main surfaces 2a and 2b spread parallel to an XY plane. The main surface 2a is disposed on a positive side in the Z-axis direction, and the main surface 2b is disposed on a negative side in the Z-axis direction.

The first electrode 3A and the second electrode 3B are conductive layers provided on any of the main surfaces 2a and 2b of the element body 2. In the present embodiment, both the first electrode 3A and the second electrode 3B are provided on the main surface 2a. Further, the electrodes 3A and 3B are arranged so as to be separated from each other in the X-axis direction at a central position in the X-axis direction. The first electrode 3A is disposed on a positive side in the X-axis direction, and the second electrode 3B is disposed on a negative side in the X-axis direction. A gap GP1 is formed between the electrodes 3A and 3B. In the gap GP1, the main surface 2a of the element body 2 is exposed from the electrodes 3A and 3B. One of the electrodes 3A and 3B is a positive electrode, and the other is a negative electrode. The electrodes 3A and 3B include a sintered layer of an electrode paste containing metal or glass. As the metal, for example, Cu, Ni, Ag, or the like can be used.

The common electrode portion 4 illustrated in FIG. 2 is a

conductive layer provided on any of the main surfaces 2a and 2b of the element body 2. The common electrode portion 4 is constituted by one or a combination of a plurality of common electrodes 10. The common electrode 10 is an electrode for forming a capacitor unit by facing another electrode, and connecting the capacitor units in series. In the present embodiment, the common electrode portion 4 is constituted by one common electrode 10A provided on the main surface 2b. As a material of the common electrode 10A, the same material as that of the electrodes 3A and 3B may be employed.

The first lead terminal 6A and the second lead terminal 6B illustrated in FIG. 1 are respectively electrically connected to the electrodes 3A and 3B. The lead terminal connected to the positive electrode is a positive terminal, and the lead terminal connected to the negative electrode is a negative terminal. The first lead terminal 6A is connected to the first electrode 3A, and the second lead terminal 6B is connected to the second electrode 3B. For connection between the lead terminals 6A and 6B and an electrode portion 3, for example, a bonding material such as solder can be used. Examples of a constituent material of the lead terminals 6A and 6B include phosphor bronze, stainless steel, and a Ni—Fe alloy (for example, a 42 alloy). A metal plating layer such as a Ni plating layer or a Sn plating layer may be provided on surfaces of the lead terminals 6A and 6B. The plating layer may be either a single layer or a multilayer.

The exterior resin 7 illustrated in FIGS. 1 and 2 is a member that protects a main portion of the element body 2 and the like. The exterior resin 7 is provided to cover the element body 2 and base end portions of the lead terminals 6A and 6B. The exterior resin 7 is constituted of, for example, a resin material having insulating properties. Examples of the resin material constituting the exterior resin 7 include epoxy resin and silica. The exterior resin 7 is formed by, for example, a dipping method or injection molding using a mold. The exterior resin 7 schematically has a shape corresponding to shapes of the element body 2, the electrodes 3A and 3B, and the lead terminals 6A and 6B. The exterior resin 7 may be in close contact with surfaces of the element body 2, the electrodes 3A and 3B, and the lead terminals 6A and 6B on their inner peripheral sides. Therefore, as illustrated in FIG.

2, the material of the exterior resin 7 enters the gap GP1 between the electrodes 3A and 3B so as to be in close contact with the main surface 2a, and the exterior resin 7 is interposed between the electrodes 3A and 3B.

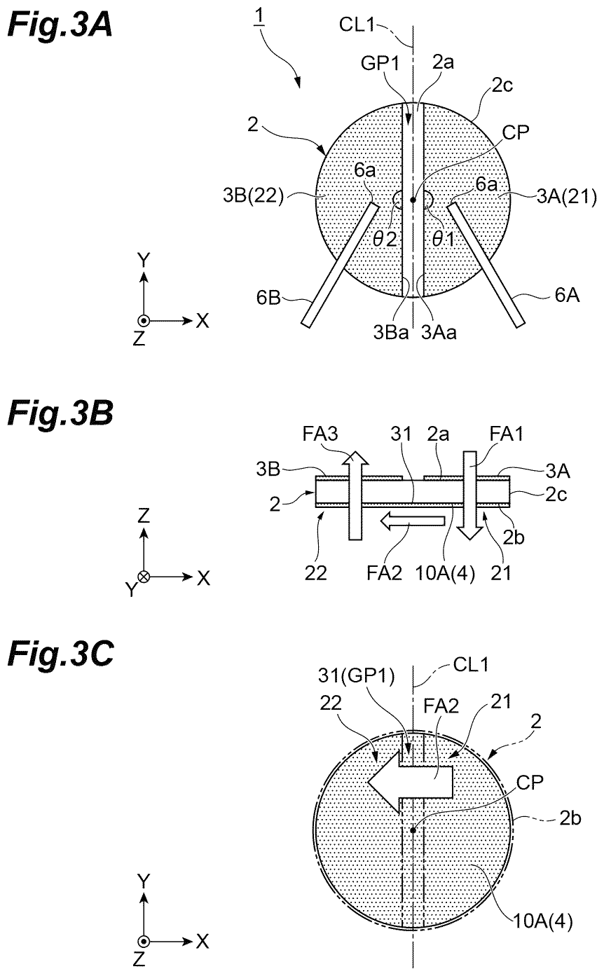

Next, a configuration of the single-plate capacitor 1 will be described in more detail with reference to FIGS. 3A to 3C. FIGS. 3A to 3C are views illustrating a structure of the electrode and the common electrode. FIG. 3A is a view of the single-plate capacitor 1 in which the exterior resin 7 is omitted as viewed from the positive side to the negative side in the Z-axis direction. FIG. 3B is a view of the single-plate capacitor 1 in which the exterior resin 7 and the lead terminals 6A and 6B are omitted as viewed from the negative side to the positive side in the Y-axis direction. FIG. 3C is a view of the electrode on the main surface 2b side of the element body 2 as viewed from the positive side to the negative side in the Z-axis direction. Note that in FIG. 3C, the main surface 2b of the element body 2 is illustrated by a virtual line.

FIGS. 3A and 3C illustrate a center point CP of the element body 2 when viewed from the Z-axis direction.

As illustrated in FIG. 3A, the electrodes 3A and 3B are provided to cover substantially an entire region of the main surface 2a of the element body 2 other than the gap GP1. Therefore, outer peripheral edges of the electrodes 3A and 3B extend to a boundary between the main surface 2a and the outer peripheral surface 2c. The common electrode 10A is provided to cover substantially an entire region of the main surface 2b. Therefore, an outer peripheral edge of the common electrode 10A extends to a boundary between main surface 2b and the outer peripheral surface 2c. Note that in FIG. 3C, the main surface 2b is illustrated to be slightly larger than the common electrode 10A so as not to overlap the outer peripheral edge of the common electrode 10A. The same applies to the following drawings.

The electrodes 3A and 3B respectively have edges 3Aa and 3Ba extending in a radial direction from the center point CP side. In the present embodiment, the edges 3Aa and 3Ba of the electrodes 3A and 3B extend linearly so as to be parallel to the center line CL1. Therefore, the gap GP1 between the electrodes 3A and 3B extends linearly in the Y-axis direction so as to be parallel to the center line CL1. Further, a width of the gap GP1, that is, a distance between the electrodes 3A and 3B is substantially equal at each position in the Y-axis direction.

Here, when viewed from the Z-axis direction (a first direction) in which the main surfaces 2a and 2b face each other, inner peripheral side portions of the electrodes 3A and 3B form predetermined angles θ1 and θ2. Note that the inner peripheral side portions of the electrodes 3A and 3B are portions closest to the center point CP among the edges 3Aa and 3Ba of the electrodes 3A and 3B. Note that an inner peripheral side portion of each of the following common electrodes 10 is also a similar portion. In the present embodiment, the angles θ1 and θ2 of the electrodes 3A and 3B are approximately 180°. Note that in the present specification, “approximately XX°” refers to an angle including XX° and within a range in which a deviation (for example, ±several°) due to a manufacturing error from the XX° is allowed.

A member electrically connected to the first electrode 3A via solder is only the first lead terminal 6A. A member electrically connected to the second electrode 3B via solder is only the second lead terminal 6B. That is, other electronic components such as a resistor, and a conductor member and the like are not connected to the electrodes 3A and 3B via solder. Tip ends 6a on connection sides of the lead terminals 6A and 6B do not protrude from the electrodes 3A and 3B as viewed from the Z-axis direction. That is, the tip ends 6a of the lead terminals 6A and 6B are connected to the electrodes 3A and 3B by soldering and are not connected to other conductive members. The lead terminals 6A and 6B are drawn out from the electrodes 3A and 3B in a state where the lead terminals 6A and 6B are spread so that a distance between the lead terminals 6A and 6B increases. Specifically, the first lead terminal 6A extends inclined toward the positive side in the X-axis direction as it goes toward the negative side in the Y-axis direction. The second lead terminal 6B extends inclined toward the negative side in the X-axis direction as it goes toward the negative side in the Y-axis direction. However, a drawing direction and a shape of the lead terminals 6A and 6B are not particularly limited. Note that since both the electrodes 3A and 3B are provided on the main surface 2a, both the lead terminals 6A and 6B are provided on the main surface 2a side. Therefore, as compared with a case where the lead terminals 6A and 6B are respectively provided on the main surfaces 2a and 2b, the lead terminals 6A and 6B can have the same shape, length, and the like. In addition, a size of the single-plate capacitor 1 in the Z-axis direction can be reduced.

Next, the size of the single-plate capacitor 1 will be described. A thickness (dimension in the Z-axis direction) of the element body 2 is preferably 1.0 mm or less, and more preferably 0.6 mm or less. Within such a range, breakdown field strength of the single-plate capacitor 1 can be increased. The breakdown field strength is a value obtained by dividing an applied voltage at which the single-plate capacitor 1 breaks down by a thickness of a dielectric (the element body 2). Note that a lower limit value of the thickness of the element body 2 is not particularly limited, but is preferably, for example, 0.1 mm or more. Within such a range, the breakdown field strength can be increased within a range that can be manufactured as the single-plate capacitor. A diameter of the element body 2 is preferably 7 mm or more, and more preferably 10 mm or more. Within such a range, capacity can be secured even when the single-plate capacitor 1 is divided into a plurality of capacitor units. An upper limit value of the diameter of the element body 2 is not particularly limited, but is preferably 20 mm or less. Within such a range, it is possible to suppress becoming too large of the single-plate capacitor 1 and affecting mounting. The distance between the electrodes in the gap GP1 is preferably 0.5 mm or more, and more preferably 1 mm or more. Within such a range, the insulating properties between the electrodes can be more reliably ensured. An upper limit value of the distance between the electrodes is not particularly limited, but is preferably 2 mm or less. Within such a range, it is possible to suppress an increase in a portion that does not contribute to the capacity. A relative permittivity of the element body 2 is not particularly limited as long as it is a general dielectric used for a ceramic capacitor (for example, 10 or more). Note that thicknesses of the electrodes 3A and 3B and the common electrode 10A are not particularly limited, but may be set to 0.1 μm or more and 10 μm or less.

As described above, no member that electrically connects the electrodes 3A and 3B, such as the resistor or the conductor member, is provided between the electrodes 3A and 3B. In the gap GP1 between the first electrode 3A and the second electrode 3B, the exterior resin 7 is disposed over substantially the entire region (see FIG. 2). In this manner, the first electrode 3A and the second electrode 3B are insulated from each other on the surface (the main surfaces 2a and 2b and the outer peripheral surface 2c) of the element body 2. In the present embodiment, the first electrode 3A and the second electrode 3B are insulated from each other on the main surface 2a.

With the above-mentioned configuration, with the first electrode 3A and the common electrode 10A facing each other in the Z-axis direction with the element body 2 interposed therebetween, a first capacitor unit 21 is formed. With the second electrode 3B and the common electrode 10A facing each other with the element body 2 interposed therebetween, a second capacitor unit 22 is formed. Here, a portion of the common electrode 10A facing the gap GP1 functions as a connection portion 31 that electrically connects the first capacitor unit 21 and the second capacitor unit 22. Therefore, the first capacitor unit 21 and the second capacitor unit 22 are connected in series via the connection portion 31 of the common electrode 10A.

Here, in the present embodiment, an area of the first electrode 3A and an area of the second electrode 3B are substantially equal to each other when viewed from the Z-axis direction. Therefore, facing areas of the electrodes 3A and 3B and the common electrode 10A in the two capacitor units 21 and 22 are substantially equal to each other.

Flow of current will be described. The current introduced into the first electrode 3A via the lead terminal 6A passes through the first capacitor unit 21 and flows to the common electrode 10A (FA1 in FIG. 3B). The current flows from the first capacitor unit 21 side to the second capacitor unit 22 side through the connection portion 31 in the common electrode 10A (FA2 in FIGS. 3B and 3C). The current passes through the second capacitor unit 22, is introduced into the second electrode 3B (FA3 in FIG. 3B), and flows to the lead terminal 6B.

Next, operations and effects of the single-plate capacitor 1 according to the present embodiment will be described.

Here, breakdown voltage resistance of the single-plate capacitor 1 will be described. The breakdown voltage resistance is a parameter for applying a voltage until a product is broken, and evaluating a level of the voltage when the product is broken. In the ceramic capacitor, the value (breakdown field strength) obtained by dividing the applied voltage that leads to breakdown by a dielectric thickness tends to increase as the dielectric thickness decreases. When the capacitors are arranged in series and the voltage is applied, the voltage is divided and applied to each capacitor. The voltage applied to each capacitor is proportional to a reciprocal of the capacity of each capacitor. For example, when two capacitors have the same capacity, the voltage is ½ by connecting the capacitors in series. When considering (a composite of) capacitors in which the dielectric thickness is reduced and the number of series is increased, the breakdown voltage resistance of each capacitor is reduced due to reduction in the dielectric thickness, but the applied voltage decreases according to the number of series by adopting a series structure. Then, as described above, the breakdown field strength increases as the dielectric thickness decreases. Therefore, in the capacitor of the series structure, the breakdown voltage resistance of an entire structure may be improved in consideration of an increase or decrease in the applied voltage and an increase in the breakdown field strength due to thinning.

The single-plate capacitor 1 according to the present embodiment includes the first lead terminal 6A connected to the first electrode 3A and the second lead terminal 6B connected to the second electrode 3B. Therefore, the single-plate capacitor 1 can be mounted on the circuit board by the lead terminals 6A and 6B. The single-plate capacitor 1 includes the common electrode portion 4 in addition to the first electrode 3A and the second electrode 3B. With the first electrode 3A and the common electrode portion 4 facing each other with the element body 2 interposed therebetween, the first capacitor unit 21 is formed. Further, with second electrode 3B and the common electrode portion 4 facing each other with the element body 2 interposed therebetween, the second capacitor unit 22 is formed. The first capacitor unit 21 and the second capacitor unit 22 are connected in series. On the other hand, since the first electrode 3A and the second electrode 3B are insulated from each other on a surface of the element body 2, the flow of current between both the electrodes can be suppressed. Therefore, the current flowing between the first electrode 3A and the second electrode 3B to which the lead terminals 6A and 6B are connected does not directly flow between the electrodes, but can flow to the first capacitor unit 21 and the second capacitor unit 22. In this manner, the plurality of capacitor units 21 and 22 connected in series can be formed in one element body 2. Since the voltage applied to each of the capacitor units 21 and 22 can be reduced, resistance to voltage as the single-plate capacitor 1 can be improved. Thus, the resistance to voltage of the single-plate capacitor 1 can be improved. In addition, as described above, by reducing the thickness of the element body 2 while increasing the number of series of the capacitor units, the resistance to voltage can be further improved.

The first electrode 3A and the second electrode 3B may be provided on one main surface 2a, the common electrode portion 4 may be provided on the other main surface 2b and include the common electrode 10A facing the first electrode 3A and the second electrode 3B, the first capacitor unit 21 and the second capacitor unit 22 may be connected in series with the common electrode 10A interposed therebetween, and the first electrode 3A and the second electrode 3B may be insulated from each other on the one main surface 2a. In this manner, the two capacitor units 21 and 22 directly connected by the one element body 2 can be formed.

The exterior resin 7 may be disposed between the first electrode 3A and the second electrode 3B. In this case, a short circuit or the like between the first electrode 3A and the second electrode 3B can be suppressed, and the resistance to voltage of the single-plate capacitor 1 can be improved.

The member electrically connected to the first electrode 3A via solder may be only the first lead terminal 6A. That is, the resistor or the like is not connected to the first electrode 3A. In this case, it is possible to suppress generation of stray capacitance between the first electrode 3A and the second electrode 3B, and form the capacitor units 21 and 22 connected in series.

The facing areas of the electrodes 3A and 3B and the common

electrode 10A in the plurality of capacitor units 21 and 22 may be substantially equal to each other. In this case, capacitances of the capacitor units 21 and 22 can be made substantially equal to each other, and by making voltages applied to the respective capacitor units 21 and 22 substantially equal, a short circuit failure or the like in any of the capacitor units 21 and 22 can be suppressed, and the breakdown can be suppressed. For example, when a difference in capacitance between a plurality of capacitors is large, a variation in voltage may increase.

The present disclosure is not limited to the above-described embodiment.

For example, the single-plate capacitor 1 according to the above-described embodiment has a series connection structure of two capacitor units. Alternatively, the single-plate capacitor 1 may have a series connection structure of three or more capacitor units. That is, the common electrode portion 4 may include a plurality of common electrodes 10, and the plurality of common electrodes 10 may face each other with the element body 2 interposed therebetween. In this case, three or more capacitor units can be formed by using the plurality of common electrodes 10. Note that in the following descriptions of modifications, descriptions of parts common to the single-plate capacitor 1 according to the above-described embodiments are omitted, but the same operations and effects can be obtained for the common configurations.

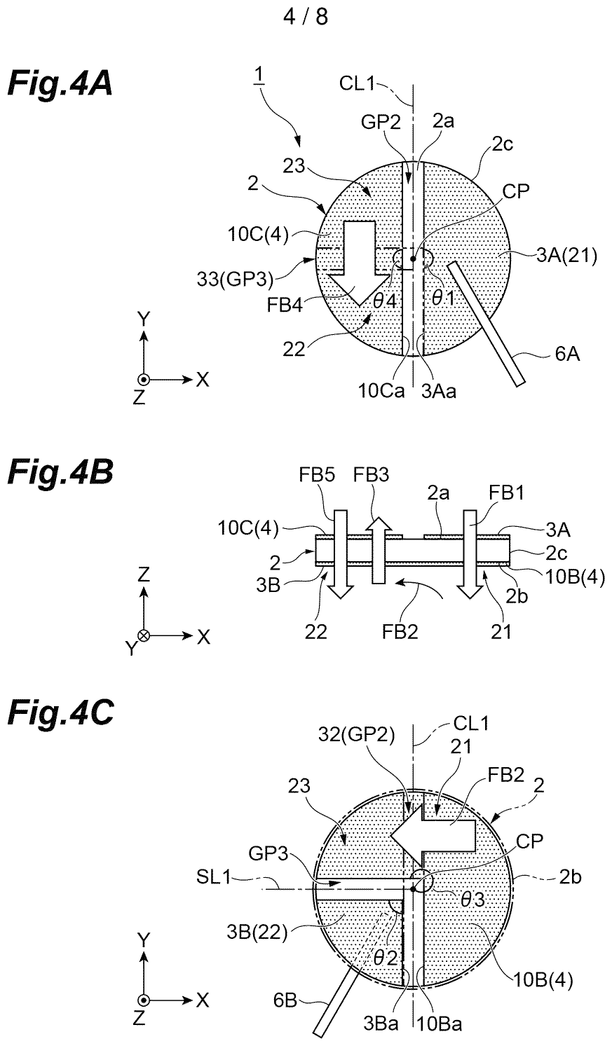

For example, a structure of the single-plate capacitor 1 illustrated in FIGS. 4A to 4C may be employed. The common electrode portion 4 includes a first common electrode 10B and a second common electrode 10C. With the first electrode 3A and the first common electrode 10B facing each other with the element body 2 interposed therebetween, the first capacitor unit 21 is formed. With the second electrode 3B and the second common electrode 10C facing each other with the element body 2 interposed therebetween, the second capacitor unit 22 is formed. With the first common electrode 10B and the second common electrode 10C facing each other with the element body 2 interposed therebetween, a third capacitor unit 23 is formed. In this case, three capacitor units 21,22, and 23 connected in series by one element body 2 can be formed.

The first electrode 3A and the second common electrode 10C are provided on the one main surface 2a (see FIGS. 4A and 4B), and the second electrode 3B and the first common electrode 10B are provided on the other main surface 2b (FIGS. 4B and 4C). In this case, the first lead terminal 6A is disposed on the one main surface 2a side, and the second lead terminal 6B is disposed on the other main surface 2b side. Thus, the element body 2 can be sandwiched between the lead terminals 6A and 6B. Therefore, thickness of the exterior resin 7 on each of the main surfaces 2a and 2b can be made uniform.

A shape of the second common electrode 10C on the main surface 2a is the same as that of the second electrode 3B illustrated in FIG. 3A. As illustrated in FIG. 4A, the second common electrode 10C has an edge 10Ca extending in the radial direction from the center point CP side. In the present embodiment, the edge 10Ca extends linearly so as to be parallel to the center line CL1. Therefore, a gap GP2 between the electrodes 3A and 10C extends linearly in the Y-axis direction so as to be parallel to the center line CL1. Further, a width of the gap GP2, that is, a distance between the electrodes 3A and 10C is substantially equal at each position in the Y-axis direction.

As illustrated in FIG. 4C, a reference line SL1 extending from the center point CP to the negative side in the X-axis direction is set with respect to the main surface 2b. At this time, a gap GP3 between the second electrode 3B and the first common electrode 10B has an L-shape. The gap GP3 has a portion extending from the center point CP to the negative side in the X-axis direction along the reference line SL1 and a portion extending from the center point CP to the negative side in the Y-axis direction along the center line CL1. The second electrode 3B and the first common electrode 10B have edges 3Ba and 10Ba extending in the radial direction from the center point CP side. In the present embodiment, the edges 3Ba and 10Ba extend in the L-shape so as to be parallel to the reference line SL1 and the center line CL1 in each portion. Therefore, the gap GP3 between the electrodes 3B and 10B extends linearly in the X-axis direction and the Y-axis direction so as to be parallel to the reference line SL1 and the center line CL1 in each portion. Further, a width of the gap GP3, that is, a distance between the electrodes 3B and 10B is substantially equal at each position.

As illustrated in FIGS. 4A and 4C, when viewed from the Z-axis direction (first direction) in which the main surfaces 2a and 2b face each other, inner peripheral side portions of the electrodes 3A and 3B, the first common electrode 10B, and the second common electrode 10C form predetermined angles θ1, θ2, θ3, and θ4. The angles θ1 and θ4 of the first electrode 3A and the second common electrode 10C are approximately 180°. The angle θ3 of the first common electrode 10B is approximately 270°. The angle θ2 of the second electrode 3B is approximately 90°.

As illustrated in FIG. 4C, a portion of the first common electrode 10B facing the gap GP2 functions as a connection portion 32 that electrically connects the first capacitor unit 21 and the third capacitor unit 23. Therefore, the first capacitor unit 21 and the third capacitor unit 23 are connected in series via the connection portion 32 of the common electrode 10B. As illustrated in FIG. 4A, a portion of the common electrode 10C facing gap GP3 functions as a connection portion 33 that electrically connects the second capacitor unit 22 and the third capacitor unit 23. Therefore, the second capacitor unit 22 and the third capacitor unit 23 are connected in series via the connection portion 33 of the common electrode 10C.

Flow of current will be described. The current introduced into the first electrode 3A via the lead terminal 6A passes through the first capacitor unit 21 and flows to the first common electrode 10B (FB1 in FIG. 4B). The current flows from the first capacitor unit 21 side to the third capacitor unit 23 side through the connection portion 32 in the first common electrode 10B (FB2 in FIGS. 4B and 4C). The current passes through the third capacitor unit 23 and flows to the second common electrode 10C (FB3 in FIG. 4B). The current flows from the third capacitor unit 23 side to the second capacitor unit 22 side through the connection portion 33 in the second common electrode 10C (FB4 in FIG. 4A). The current passes through the second capacitor unit 22, is introduced into the second electrode 3B (FB5 in FIG. 4B), and flows to the lead terminal 6B.

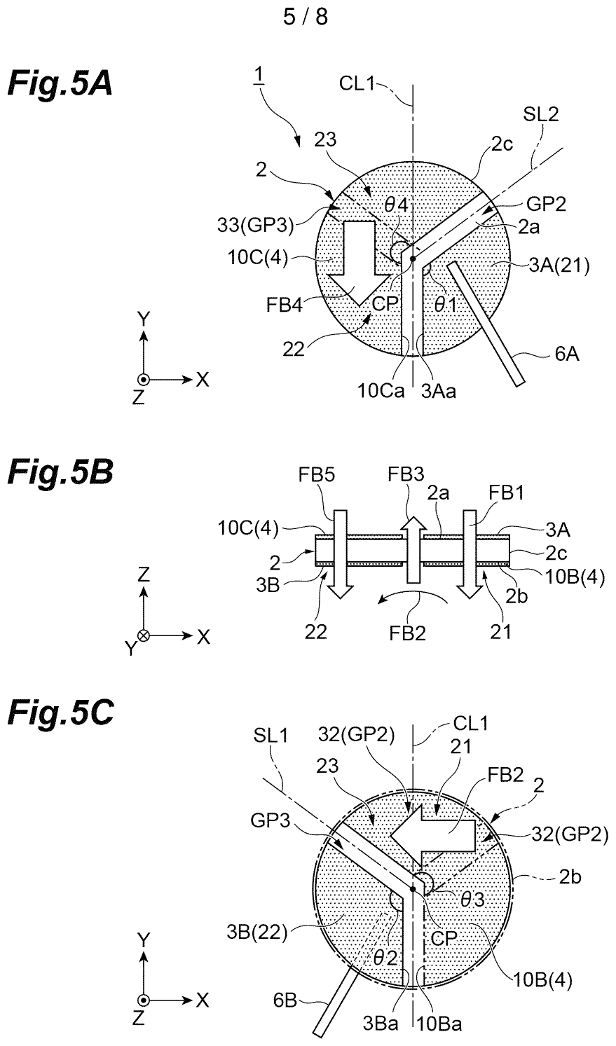

In addition, a form illustrated in FIGS. 5A to 5C may be employed as the series connection structure of the three capacitor units 21,22, and 23.

As illustrated in FIG. 5A, a reference line SL2 extending inclined toward the positive side in the Y-axis direction from the center point CP as it goes toward the positive side in the X-axis direction is set with respect to the main surface 2a. At this time, the gap GP2 between the first electrode 3A and the second common electrode 10C has a V-shape. The gap GP2 has a portion extending from the center point CP along the reference line SL2 so as to be inclined to the positive side in the X-axis direction and a portion extending from the center point CP along the center line CL1 to the negative side in the Y-axis direction. The first electrode 3A and the second common electrode 10C have edges 3Aa and 10Ca extending in the radial direction from the center point CP side. In the present embodiment, the edges 3Aa and 10Ca extend in the V-shape so as to be parallel to the reference line SL2 and the center line CL1 in each portion. Therefore, the gap GP2 between the electrodes 3A and 10C extends linearly in a direction inclined with respect to the X-axis direction and in the Y-axis direction so as to be parallel to the reference line SL2 and the center line CL1 in each portion. Further, the width of the gap GP2, that is, the distance between the electrodes 3A and 10C is substantially equal at each position.

As illustrated in FIG. 5C, a reference line SL1 extending inclined toward the positive side in the Y-axis direction from the center point CP as it goes toward the negative side in the X-axis direction is set with respect to the main surface 2b. At this time, a gap GP3 between the second electrode 3B and the first common electrode 10B has a V-shape. The gap GP3 has a portion extending from the center point CP along the reference line SL1 so as to be inclined to the negative side in the X-axis direction and a portion extending from the center point CP along the center line CL1 to the negative side in the Y-axis direction. The second electrode 3B and the first common electrode 10B have edges 3Ba and 10Ba extending in the radial direction from the center point CP side. In the present embodiment, the edges 3Ba and 10Ba extend in the V-shape so as to be parallel to the reference line SL1 and the center line CL1 in each portion. Therefore, the gap GP3 between the electrodes 3B and 10B extends linearly in the direction inclined with respect to the X-axis direction and in the Y-axis direction so as to be parallel to the reference line SL1 and the center line CL1 in each portion. Further, the width of the gap GP3, that is, the distance between the electrodes 3B and 10B is substantially equal at each position.

As illustrated in FIGS. 5A and 5C, when viewed from the Z-axis direction (first direction) in which the main surfaces 2a and 2b face each other, the inner peripheral side portions of the electrodes 3A and 3B, the first common electrode 10B, and the second common electrode 10C form the predetermined angles θ1, θ2, θ3, and θ4. The angles θ1 and θ2 of the first electrode 3A and the second electrode 3B are approximately 120°. The angles θ3 and θ4 of the first common electrode 10B and the second common electrode 10C are approximately 240°.

In the present embodiment, facing areas of the electrodes 3A and 3B and the common electrodes 10B and 10C in the plurality of capacitor units 21,22, and 23 are substantially equal to each other. In this case, capacitances of the capacitor units 21,22, and 23 can be made substantially equal to each other, and by making voltages applied to the capacitor units 21,22, and 23 substantially equal, the short circuit failure or the like in any of the capacitor units 21,22, and 23 can be suppressed, and the breakdown can be suppressed.

Note that other structures of configuration and the flow of current of FIGS. 5A to 5C are the same as those of configuration of FIGS. 4A to 4C.

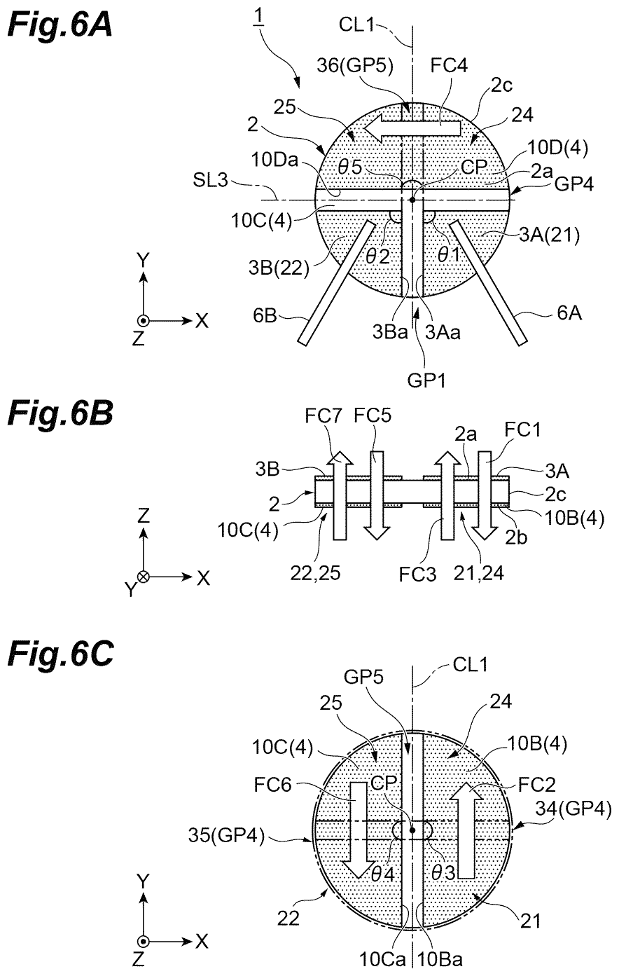

Furthermore, the single-plate capacitor 1 illustrated in FIGS. 6A to 6C may be employed. The common electrode portion 4 includes the first common electrode 10B, the second common electrode 10C, and a third common electrode 10D. With the first electrode 3A and the first common electrode 10B facing each other with the element body 2 interposed therebetween, the first capacitor unit 21 is formed. With the second electrode 3B and the second common electrode 10C facing each other with the element body 2 interposed therebetween, the second capacitor unit 22 is formed. With the first common electrode 10B and the third common electrode 10D facing each other with the element body 2 interposed therebetween, a fourth capacitor unit 24 is formed. With the second common electrode 10C and the third common electrode 10D facing each other with the element body 2 interposed therebetween, a fifth capacitor unit 25 is formed. In this case, four capacitor units connected in series by one element body 2 can be formed.

The first electrode 3A, the second electrode 3B, and the third common electrode 10D are provided on the one main surface 2a, and the first common electrode 10B and the second common electrode 10C are provided on the other main surface 2b. Thus, both the lead terminals 6A and 6B can be arranged on the one main surface 2a side.

Therefore, the lead terminals 6A and 6B can have the same shape, length, or the like.

As illustrated in FIG. 6A, a reference line SL3 extending from the center point CP in the X-axis direction is set with respect to the main surface 2a. At this time, the gap GP4 between the third common electrode 10D and the electrodes 3A and 3B has a shape extending linearly in the X-axis direction. The third common electrode 10D has an edge 10Da extending in the radial direction from the center line side. The gap GP1 between the electrodes 3A and 3B has a shape linearly extending from the center point CP to the negative side in the X-axis direction. In the present embodiment, the edges 3Aa and 3Ba of the electrodes 3A and 3B have an L-shape having a portion extending linearly so as to be parallel to the center line CL1 and a portion extending linearly so as to be parallel to the reference line SL3. The edge 10Da of the third common electrode 10D extends linearly so as to be parallel to the reference line SL3. Therefore, the gap GP1 between the electrodes 3A and 3B extends linearly in the Y-axis direction so as to be parallel to the center line CL1. Further, a width of the gap GP1, that is, a distance between the electrodes 3A and 3B is substantially equal at each position in the Y-axis direction. The gap GP4 between the electrodes 3A and 3B and the third common electrode 10D extends linearly in the X-axis direction so as to be parallel to the reference line SL3. Further, the width of the gap GP4, that is, the distance between the electrodes 3A and 3B and the third common electrode 10D is substantially equal at each position in the X-axis direction.

As illustrated in FIG. 6C, on the main surface 2b, the first common electrode 10B and the second common electrode 10C respectively have the edges 10Ba and 10Ca extending in the radial direction from the center point CP side. In the present embodiment, the edges 10Ba and 10Ca of the common electrodes 10B and 10C extend linearly so as to be parallel to the center line CL1. Therefore, a gap GP5 between the common electrodes 10B and 10C extends linearly in the Y-axis direction so as to be parallel to the center line CL1. Further, a width of the gap GP5, that is, a distance between the common electrodes 10B and 10C is substantially equal at each position in the Y-axis direction.

As illustrated in FIGS. 6A and 6C, when viewed from the Z-axis direction (first direction) in which the main surfaces 2a and 2b face each other, inner peripheral side portions of the first electrode 3A, the second electrode 3B, the first common electrode 10B, the second common electrode 10C, and the third common electrode 10D may form predetermined angles θ1, θ2, θ3, θ4, and θ5, the angles θ1 and θ2 of the first electrode 3A and the second electrode 3B may be approximately 90°, and the angles θ3, θ4, and θ5 of the first common electrode 10B, the second common electrode 10C, and the third common electrode 10D may be approximately 180°. In this case, capacitances of the four capacitor units 21,22,24, and 25 can be made substantially equal. Therefore, it is possible to suppress variation in the resistance to voltage in each capacitor unit.

As illustrated in FIG. 6C, a portion of the first common electrode 10B facing the gap GP4 functions as a connection portion 34 that electrically connects the first capacitor unit 21 and the fourth capacitor unit 24. Therefore, the first capacitor unit 21 and the fourth capacitor unit 24 are connected in series via the connection portion 34 of the first common electrode 10B. A portion of the second common electrode 10C facing the gap GP4 functions as a connection portion 35 that electrically connects the second capacitor unit 22 and the fifth capacitor unit 25. Therefore, the second capacitor unit 22 and the fifth capacitor unit 25 are connected in series via the connection portion 35 of the second common electrode 10C. As illustrated in FIG. 6A, a portion of the third common electrode 10D facing the gap GP5 functions as a connection portion 36 that electrically connects the fourth capacitor unit 24 and the fifth capacitor unit 25. Therefore, the fourth capacitor unit 24 and the fifth capacitor unit 25 are connected in series via the connection portion 36 of the third common electrode 10D.

Flow of current will be described. The current introduced into the first electrode 3A via the lead terminal 6A passes through the first capacitor unit 21 and flows to the first common electrode 10B (FC1 in FIG. 6B). The current flows from the first capacitor unit 21 side to the fourth capacitor unit 24 side through the connection portion 34 in the first common electrode 10B (FC2 in FIG. 6C). The current passes through the fourth capacitor unit 24 and flows to the third common electrode 10D (FC3 in FIG. 6B). The current flows from the fourth capacitor unit 24 side to the fifth capacitor unit 25 side through the connection portion 36 in the third common electrode 10D (FC4 in FIG. 6A). The current passes through the capacitor unit 25 and flows to the second common electrode 10C (FC5 in FIG. 6B). The current flows from the fifth capacitor unit 25 side to the second capacitor unit 22 side through the connection portion 35 in the second common electrode 10C (FC6 in FIG. 6C). The current passes through the capacitor unit 22, is introduced into the second electrode 3B (FC7 in FIG. 6B), and flows to the lead terminal 6B.

Facing areas of the electrodes 3A and 3B and the common electrodes 10B, 10C, and 10D in the plurality of capacitor units 21,22,24, and 25 may be substantially equal to each other. In this case, capacitances of the capacitor units 21,22,24, and 25 can be made substantially equal to each other, and by making voltages applied to the capacitor units 21,22,24, and 25 substantially equal, the short circuit failure or the like in any of the capacitor units 21,22,24, and 25 can be suppressed, and the breakdown can be suppressed.

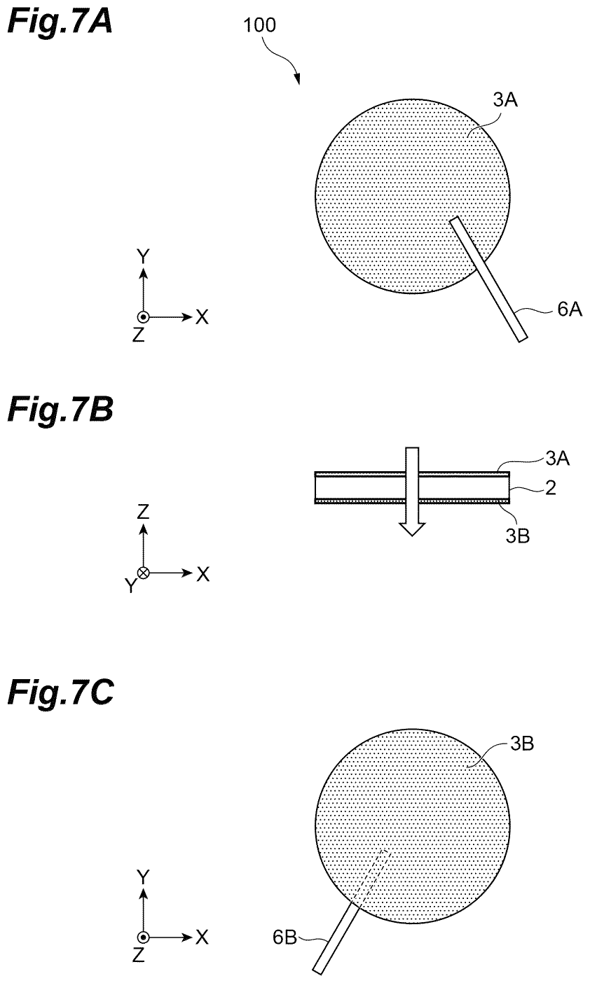

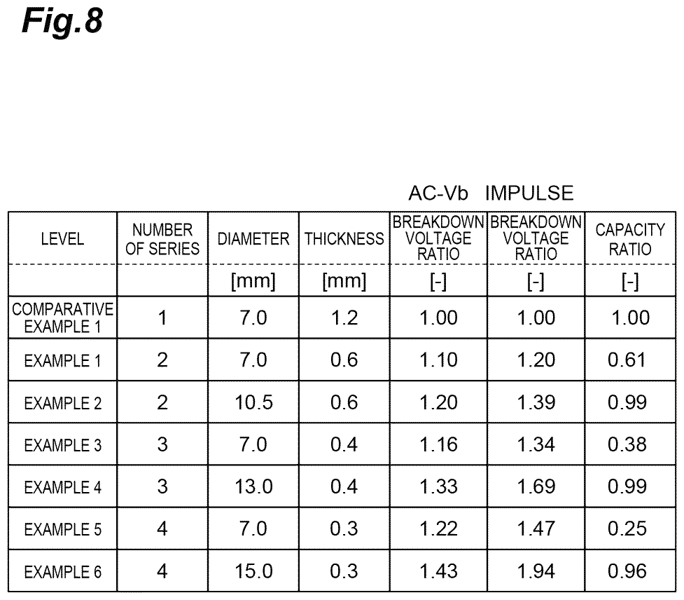

Next, evaluation results and simulation results of Examples and Comparative Examples will be described with reference to FIG. 8. As Comparative Example 1, a single-plate capacitor 100 illustrated in FIGS. 7A to 7C was employed. The single-plate capacitor 100 according to Comparative Example 1 includes the first electrode 3A and the second electrode 3B that cover front surfaces of both surfaces of the element body 2. The single-plate capacitor 100 has one capacitor unit. The diameter and thickness of the element body 2 were set to values shown in FIG. 8. As Examples 1 and 2, a single-plate capacitor having a structure in which two capacitor units as illustrated in FIGS. 3A to 3C were connected in series was employed. As Examples 3 and 4, a single-plate capacitor having a structure in which three capacitor units as illustrated in FIGS. 5A to 5C were connected in series was employed. As Examples 5 and 6, a single-plate capacitor having a structure in which four capacitor units as illustrated in FIGS. 6A to 6C were connected in series was employed. Note that in Examples 1, 3, and 5, the diameter of the element body was the same as that in Comparative Example 1, and in Examples 2, 4, and 6, the diameter of the element body was larger than that in Comparative Example 1. In addition, as the number of capacitors in series increased, the thickness of the element body was reduced so as to be inversely proportional to an increase ratio of the number of capacitors in series.

A “breakdown voltage ratio” and a “capacity ratio” were measured for Comparative Example 1 and each Example. “Breakdown voltage characteristics” is the parameter for applying the voltage until the product is broken, and evaluating the level of the voltage when the product is broken. The “breakdown voltage ratio” and the “capacity ratio” of Examples 1 to 6 indicate ratios when values of Comparative Example 1 are set to “1”. In addition, as the breakdown voltage ratio, a measurement method of “AC−Vb” and a measurement method of “impulse withstand voltage” were employed. The “AC−Vb” is a measurement method in which a voltage applied to a sample is increased at an alternating current of 50 Hz, and a voltage at the time of breakdown is recorded. The “impulse withstand voltage” is a measurement method in which the voltage is increased by a measurement method conforming to conditions described in “JIS C504-14:2014”, and the voltage at the time of breakdown is recorded. As shown in FIG. 8, it was confirmed that by increasing the number of series and reducing the thickness of the element body (0.6 mm or less), the breakdown voltage ratio can be improved more than by a dispersion effect of the withstand voltage due to serialization in both the “AC−Vb” and the “impulse withstand voltage”. Further, as for the capacity ratio, from the results of Examples 2, 4, and 6, it was confirmed that a capacity ratio equivalent to that of Comparative Example 1 can be obtained by increasing the diameter of the element body (10 mm or more) together with an effect of reducing the thickness.

The present disclosure is not limited to the above-described embodiment.

The configurations of the above-described embodiments and modifications are merely examples, and can be appropriately changed within the scope of the gist of the present disclosure. For example, the number of series is up to four in the above examples, but a greater number of series may be employed.

### [Form 1]

A capacitor including:

an element body having a pair of main surfaces facing each other;

a first electrode, a second electrode, and a common electrode portion provided on any of the main surfaces of the element body;

a first lead terminal connected to the first electrode by soldering; and

a second lead terminal connected to the second electrode by soldering, in which

the first electrode and the common electrode portion face each other with the element body interposed therebetween to form a first capacitor unit,

the second electrode and the common electrode portion face each other with the element body interposed therebetween to form a second capacitor unit,

the first capacitor unit and the second capacitor unit are connected in series, and

the first electrode and the second electrode are insulated from each other on a surface of the element body.

### [Form 2]

The capacitor according to the Form 1, in which

the first electrode and the second electrode are provided on one of the main surfaces,

the common electrode portion is provided on the other of the main surfaces and includes a common electrode facing the first electrode and the second electrode,

the first capacitor unit and the second capacitor unit are connected in series with the common electrode interposed therebetween, and

the first electrode and the second electrode are insulated from each other on the one of the main surfaces.

### [Form 3]

The capacitor according to the Form 1 or 2, in which the common electrode portion includes a plurality of common electrodes, and the plurality of common electrodes face each other with the element body interposed therebetween.

### [Form 4]

The capacitor according to the Form 3, in which

the common electrode portion includes a first common electrode and a second common electrode,

the first electrode and the first common electrode face each other with the element body interposed therebetween to form the first capacitor unit,

the second electrode and the second common electrode face each other with the element body interposed therebetween to form the second capacitor unit, and

the first common electrode and the second common electrode face each other with the element body interposed therebetween to form a third capacitor unit.

### [Form 5]

The capacitor according to the Form 4, in which

when viewed from a first direction in which the pair of main surfaces faces each other, inner peripheral side portions of the first electrode, the second electrode, the first common electrode, and the second common electrode form predetermined angles,

the angles of the first electrode and the second electrode are approximately 120°, and

the angles of the first common electrode and the second common electrode are approximately 240°.

### [Form 6]

The capacitor according to the Form 4 or 5, in which

the first electrode and the second common electrode are provided on one of the main surfaces, and

the second electrode and the first common electrode are provided on the other of the main surfaces.

### [Form 7]

The capacitor according to the Form 3, in which

the common electrode portion includes a first common electrode, a second common electrode, and a third common electrode,

the first electrode and the first common electrode face each other with the element body interposed therebetween to form the first capacitor unit,

the second electrode and the second common electrode face each other with the element body interposed therebetween to form the second capacitor unit,

the first common electrode and the third common electrode face each other with the element body interposed therebetween to form a fourth capacitor unit, and

the second common electrode and the third common electrode face each other with the element body interposed therebetween to form a fifth capacitor unit.

### [Form 8]

The capacitor according to the Form 7, in which

when viewed from a first direction in which the pair of main surfaces faces each other, inner peripheral side portions of the first electrode, the second electrode, the first common electrode, and the second common electrode, and the third common electrode form predetermined angles,

the angles of the first electrode and the second electrode are approximately 90°, and

the angles of the first common electrode, the second common electrode, and the third common electrode are approximately 180°.

### [Form 9]

The capacitor according to the Form 7 or 8, in which

the first electrode, the second electrode, and the third common electrode are provided on one of the main surfaces, and

the first common electrode and the second common electrode are provided on the other of the main surfaces.

### [Form 10]

The capacitor according to any one of the forms 1 to 9, in which an exterior resin is disposed between the first electrode and the second electrode.

### [Form 11]

The capacitor according to any one of the forms 1 to 10, in which a member electrically connected to the first electrode via solder is only the first lead terminal.

### [Form 12]

The capacitor according to any one of the forms 1 to 11, in which facing areas of electrodes and common electrodes in a plurality of capacitor units are substantially equal to each other.

### REFERENCE SIGNS LIST

1 single-plate capacitor (capacitor)

2 element body
3A first electrode
3B second electrode
4 common electrode portion
6A first lead terminal
6B second lead terminal
7 exterior resin
10A common electrode
10B first common electrode
10C second common electrode
10D third common electrode
21 first capacitor unit
22 second capacitor unit
23 third capacitor unit
24 fourth capacitor unit
25 fifth capacitor unit

What is claimed is:

1. A capacitor comprising:
an element body having a pair of main surfaces facing each other;
a first electrode, a second electrode, and a common electrode portion provided on any of the main surfaces of the element body;
a first lead terminal connected to the first electrode by soldering; and
a second lead terminal connected to the second electrode by soldering, wherein
the first electrode and the common electrode portion face each other with the element body interposed therebetween to form a first capacitor unit,
the second electrode and the common electrode portion face each other with the element body interposed therebetween to form a second capacitor unit,
the first capacitor unit and the second capacitor unit are connected in series, and
the first electrode and the second electrode are insulated from each other on a surface of the element body.

2. The capacitor according to claim 1, wherein
the first electrode and the second electrode are provided on one of the main surfaces,
the common electrode portion is provided on the other of the main surfaces and includes a common electrode facing the first electrode and the second electrode,
the first capacitor unit and the second capacitor unit are connected in series with the common electrode interposed therebetween, and
the first electrode and the second electrode are insulated from each other on the one of the main surfaces.

3. The capacitor according to claim 1, wherein the common electrode portion includes a plurality of common electrodes, and the plurality of common electrodes face each other with the element body interposed therebetween.

4. The capacitor according to claim 3, wherein
the common electrode portion includes a first common electrode and a second common electrode,
the first electrode and the first common electrode face each other with the element body interposed therebetween to form the first capacitor unit,
the second electrode and the second common electrode face each other with the element body interposed therebetween to form the second capacitor unit, and
the first common electrode and the second common electrode face each other with the element body interposed therebetween to form a third capacitor unit.

5. The capacitor according to claim 4, wherein
when viewed from a first direction in which the pair of main surfaces faces each other, inner peripheral side portions of the first electrode, the second electrode, the first common electrode, and the second common electrode form predetermined angles,
the angles of the first electrode and the second electrode are approximately 120°, and
the angles of the first common electrode and the second common electrode are approximately 240°.

6. The capacitor according to claim 4, wherein
the first electrode and the second common electrode are provided on one of the main surfaces, and
the second electrode and the first common electrode are provided on the other of the main surfaces.

7. The capacitor according to claim 3, wherein
the common electrode portion includes a first common electrode, a second common electrode, and a third common electrode,
the first electrode and the first common electrode face each other with the element body interposed therebetween to form the first capacitor unit,
the second electrode and the second common electrode face each other with the element body interposed therebetween to form the second capacitor unit,
the first common electrode and the third common electrode face each other with the element body interposed therebetween to form a fourth capacitor unit, and
the second common electrode and the third common electrode face each other with the element body interposed therebetween to form a fifth capacitor unit.

8. The capacitor according to claim 7, wherein
when viewed from a first direction in which the pair of main surfaces faces each other, inner peripheral side portions of the first electrode, the second electrode, the first common electrode, and the second common electrode, and the third common electrode form predetermined angles,
the angles of the first electrode and the second electrode are approximately 90°, and
the angles of the first common electrode, the second common electrode, and the third common electrode are approximately 180°.

9. The capacitor according to claim 7, wherein
the first electrode, the second electrode, and the third common electrode are provided on one of the main surfaces, and
the first common electrode and the second common electrode are provided on the other of the main surfaces.

10. The capacitor according to claim 1, wherein an exterior resin is disposed between the first electrode and the second electrode.

11. The capacitor according to claim 1, wherein a member electrically connected to the first electrode via solder is only the first lead terminal.

12. The capacitor according to any one of claim 1, wherein facing areas of electrodes and common electrodes in a plurality of capacitor units are substantially equal to each other.
